(19) United States
(12) Patent Application Publication
(10) Pub. No.: US 2015/0026290 A1
(43) Pub. Date: Jan. 22, 2015

(54) METHOD FOR MANAGING CLOUD HARD DISKS

(71) Applicant: RICHPLAY INFORMATION CO., LTD., New Taipei City (TW)

(72) Inventors: JUN-HUI WU, NEW TAIPEI CITY 238 (TW); YAN-JIUN LIN, MIAOLI COUNTY 367 (TW)

(21) Appl. No.: 14/330,040

(22) Filed: Jul. 14, 2014

(30) Foreign Application Priority Data
Jul. 19, 2013 (TW) 102125882

(51) Int. Cl. G06F 3/06

(52) U.S. Cl. CPC G06F 3/0604; G06F 3/0655; G06F 3/0689; G06F 3/067; G06F 2003/0692; G06F 2003/0697
USPC 709/214

(57) ABSTRACT

The present invention provides a method for managing cloud hard disks. A plurality of hard disk spaces are first logged in to a client unit. Thereby, when the client unit accesses at least a personal datum, the client unit can distribute according to the required hard disk space of the accessed datum without checking the plurality of hard disk spaces one by one. Accordingly, it becomes more convenient for users in using hard disk spaces.

### FIELD OF THE INVENTION

The present invention relates generally to a method for managing cloud, and particularly to a method for managing cloud hard disks.

### BACKGROUND OF THE INVENTION

As the digital age comes, the interaction between human and electronic products becomes frequent increasingly. Nonetheless, the operational interface of current electronic products can no longer satisfy users' requirements. The most used application in people's daily lives is the network. For example, network devices are added in electronic products, enabling people to operate the electronic products through networks. Thereby, the operations of the electronic products are more convenient, and the added values of the electronic products are increased significantly.

The trend of modern consumer internet commodities is developing towards remote processing, such as mobile management, remote control, and remote data access. Consequently, cloud operations emerge as the prosperous development of mobile networking. Besides, owing to their different positions in supply and demand, mobile networking and the general Ethernet are complementary, which makes networks prevail worldwide. People can access to the Internet everywhere via various options of getting connected. For example, 3G networks, Wi-Fi, cellular networks, and Bluetooth networks are short-distance or long-distance connecting mechanisms. As a consequence, data access is no longer done by using portable mobile hard disks. Instead, it is done by using cloud hard disks.

Cloud hard disks are also called the network space. In general, on the Internet, there are many supplier of network space, including the domestic Chunghwa Telecom and Accton, and the Freakshare and Mega-upload overseas. As the free network space elicits commercial opportunities with distinct values, many network companies or community websites are also involved in the broad commercial opportunities of the free network space. For example, Google drive of Google, Skydrive of Microsoft, and Dropbox all provide free spaces. Thereby, people can have multiple choices of free network space. which can be used as the cloud hard disk space.

Nonetheless, no matter pay or free cloud hard disk space, users have to login before they can use it. In addition, users have to login the portals of respective cloud hard disk space, or they should download the corresponding application programs, respectively, before they can access personal data. Moreover, if the quantity of personal data is huge, or even larger than a single cloud hard disk space, users need to distribute their data to various cloud hard disk spaces. They usually also need to remember the capacity of respective cloud hard disk space for preventing the quantity of their data from exceeding the capacity of cloud hard disk space. This brings extreme inconvenience to users.

Accordingly, the present invention provides a method for managing cloud hard disks, which integrates cloud hard disk spaces. In addition, regarding to data access, cloud hard disk spaces can be allocated effectively. It is not necessary to worry insufficiency in the capacity of cloud hard disk spaces.

### SUMMARY

An objective of the present invention is to provide a method for managing cloud hard disks, which prevents the problem of insufficiency in the capacity of cloud hard disk by integrating cloud hard disk spaces.

For achieving the objective described above, the present invention discloses a method for managing cloud hard disks. First, a client unit logins a plurality of hard disk spaces for integrating the plurality of hard disk spaces by the client unit. When a user accesses at least a personal datum using the client unit, the personal datum can be distributed by the client unit according to the remaining space of the plurality of hard disk spaces. Consequently, it is prevented that the user has to confirm the capacity of hard disk spaces one by one.

### BRIEF DESCRIPTION OF THE DRAWINGS

FIG. 1 shows a block diagram according to a preferred embodiment of the present invention;

FIG. 2 shows a flowchart according to a preferred embodiment of the present invention;

FIG. 3 shows a flowchart according to another preferred embodiment of the present invention;

FIG. 4 shows a schematic diagram of building space mapping data according to a preferred embodiment of the present invention;

FIG. 5 shows a flowchart according to another preferred embodiment of the present invention; and

FIG. 6 shows a flowchart according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a method for managing cloud hard disks. According to the present invention, users need not to confirm the capacity of cloud hard disks one by one. Instead, adient unit integrates directly the hard disk spaces of a plurality of cloud hard disks. Thereby, users can access personal data with convenience. The details of the method for managing cloud hard disks are described as follows.

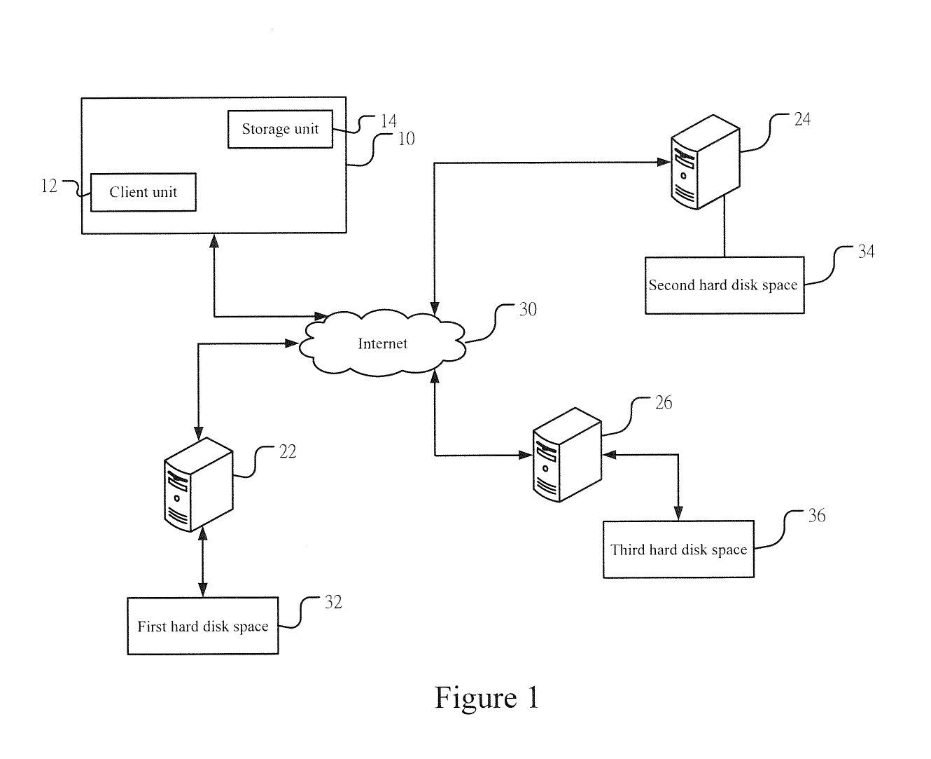

Please refer to FIG. 1, which shows a block diagram according to a preferred embodiment of the present invention. As shown in the figure, the system architecture of the method for managing cloud hard disks according to the present invention is disclosed. The method is used for integrating a plurality of hard disk spaces, so that users can access personal data in hard disk spaces conveniently. The system architecture adopted by the present invention comprises a mobile device 10, a first server 22, a second server 24, a third server 26, the Internet 30, a first hard disk space 32, a second hard disk space 34, and a third hard disk space 36. The mobile device 10 includes a client unit 12 and a storage unit 14.

According to the present invention, the client unit 12 is used for logging in a plurality of hard disk spaces and thus integrating the hard disk spaces. Thereby, the client unit 12 according to the present embodiment is executed in the mobile device 10 and connected with the Internet 30. Hence, the client unit 12 is connected to the portal websites of the first hard disk space 32. the second hard disk space 34, and the third hard disk space 36, namely, the network location of the first server 22, the second server 24, and the third server 26, for logging in the first hard disk space 32, the second hard disk space 34, and the third hard disk space 36 to the client unit 12. Thereby, the registration data of the first hard disk space 32, the second hard disk space 34, and the third hard disk space 36 are all stored in the storage unit 14. Accordingly, the first hard disk space 32, the second hard disk space 34, and the third hard disk space 36 are integrated through the client unit 12. The client unit 12 builds space mapping data of the first hard disk space 32, the second hard disk space 34, and the third hard disk space 36. In addition, the client unit 12 is used for storing the space mapping data to the storage unit 14.

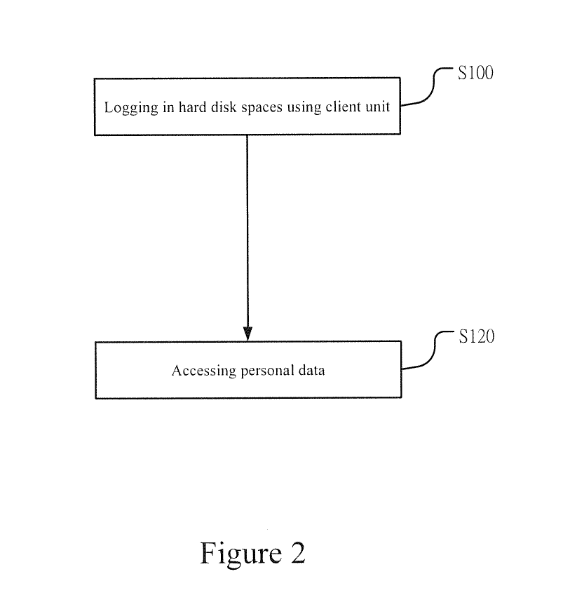

FIG. 2 shows a flowchart according to a preferred embodiment of the present invention. As shown in the figure, according to the method for managing cloud hard disks according to the present invention, a user needs not to compare the capacity of hard disk spaces one by one while accessing personal data to the hard disk spaces on the Internet. Instead, the client unit can distribute all of the user's hard disk spaces. The detailed process of the method according to the present invention is described as follows.

Step S100: Logging in hard disk spaces using the client unit; and
Step S120: Accessing personal data.

In the step S100, the user logins all of the hard disk space he owns to the client unit 12. According to the present embodiment, the first hard disk space 32, the second hard disk space 34, and the third hard disk space 36 are used as an example of the plurality of hard disk spaces. Nonetheless, the number of the hard disk spaces is not limited to three; it can be two or more hard disk spaces. The client unit 12 integrates the first hard disk space 32, the second hard disk space 34, and the third hard disk space 36 according to their registration data, which include account, password, and capacity data.

In the step S120, when the mobile 10 accesses the personal data via the client unit 12, the client unit 12 will distribute the personal data to the usable spaces of the plurality of hard disk spaces according to the plurality of hard disk spaces. Thereby, when the user is accessing data, he needs not to confirm the capacity of the individual hard disk space. By adopting the method according to the present invention, the user can access the personal data with ease and convenience; he needs not to worry about the problem of insufficiency in capacity of some hard disk spaces. The personal data include multimedia data, word processing data, or chart and table data.

Besides, the present invention can further build space mapping data according to the plurality hard disk space by using the client unit, so that the plurality of hard disk space can be integrated and operated as a single hard disk drive. The details will be described as follows.

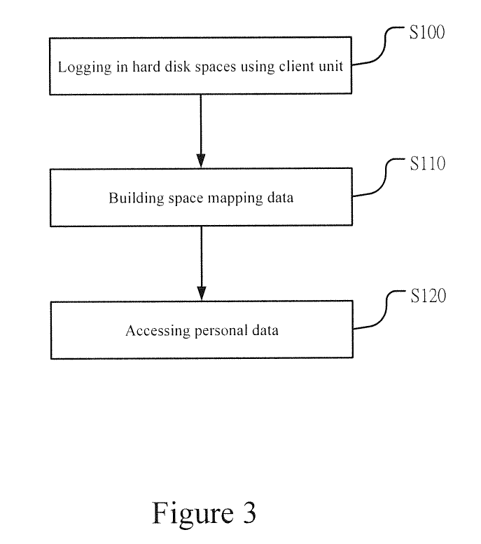

Please refer to FIG. 3, which shows a flowchart according to another preferred embodiment of the present invention. As shown in the figure, according to the method for managing cloud hard disks according to the present invention, a user needs not to compare the capacity of hard disk spaces one by one while accessing personal data to the hard disk spaces on the Internet. Instead, the client unit can distribute all of the user's hard disk spaces. The detailed process of the method according to the present invention is described as Follows.

Step S100: Logging in hard disk spaces using the client unit;
Step S110: Building space mapping data; and
Step S120: Accessing personal data.

In the following, how to integrate and manage the hard disk spaces will be described in detail.

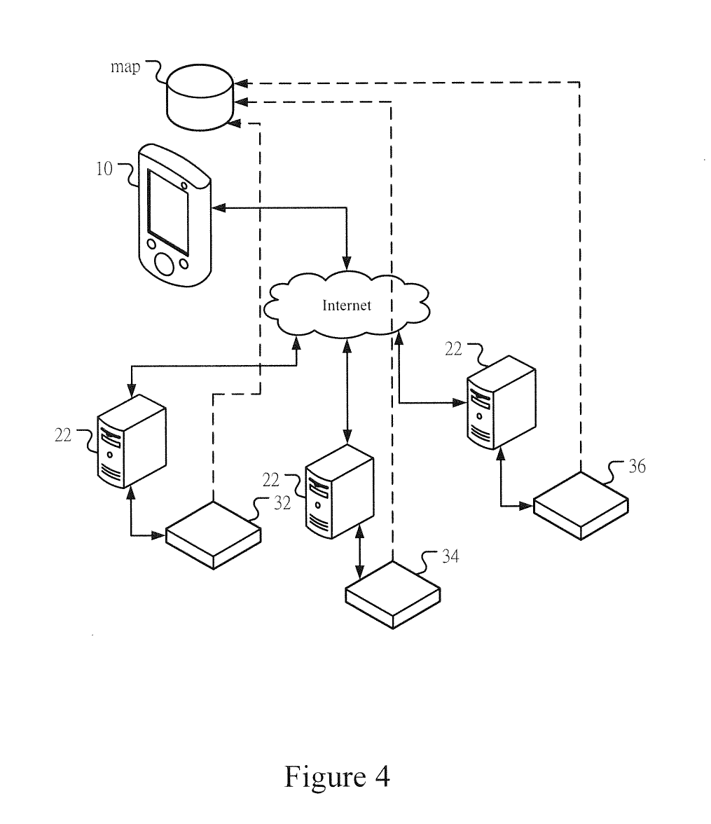

The step S100 is the same as the one in the previous embodiment. Hence, the details will not be described again. In the step S110, as shown in FIG. 4, the client unit 12 builds space mapping data map for the registered first hard disk space 32, second hard disk space 34, and third hard disk space 36. Thereby, after the client unit 12 integrates the hard disk spaces, the first hard disk space 32, the second hard disk space 34, and the third hard disk space 36 can be connected in series and operated as a single independent hard disk drive for storing data.

In the step S120, when the mobile device 10 accesses the personal data through the client unit 12, the client unit 12 accesses at least a personal datum to the plurality of hard disk spaces according to the space mapping data map. In addition, the client unit 12 distributes the personal datum to the usable space of the plurality of hard disk spaces according to the space mapping data map. Thereby, when the user is accessing data, he needs not to confirm the capacity of the individual hard disk space. By adopting the method according to the present invention, the user can access the personal data with ease and convenience; he needs not to worry about the problem of insufficiency in capacity of some hard disk spaces. The personal data include multimedia data, word processing data, or chart and table data.

In addition to the upload type of data access service as described in the above embodiment, the present invention can be further applied to synchronous access service, as described below.

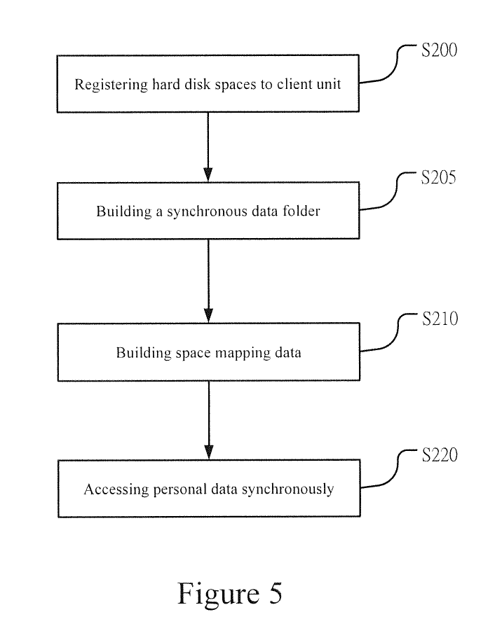

Please refer to FIG. 5, which shows a flowchart according to another preferred embodiment of the present invention. The difference between FIG. 3 and FIG. 5 is that FIG. 5 further comprises a step of building a synchronous data folder in the mobile device 10, so that the user can store the personal data to the storage unit 14 by means of the synchronous access of the client unit 12. In addition, the personal data accessed by the mobile device 10 can be synchronized to the plurality of hard disk spaces as well. In other words, the personal data accessed by the synchronous data folder of the mobile device 10 will be accessed by the plurality of hard disk spaces using synchronous transmission. The method according to the present invention comprises steps of:

Step S200: Registering hard disk spaces to the client unit;
Step S205: Building a synchronous data folder;
Step S210: Building space mapping data; and
Step S220: Accessing personal data synchronously.

In the steps S200 and S210, the operations are the same as the steps S100 and S110 as described above. Hence, the details will not be described again. In the step @05, the client unit 12 builds a synchronous data folder in the storage unit 14. Thereby, in the step S220, the client unit 12 synchronizes the accessed data in the synchronous data folder to the hard disk spaces. That is, the data in the synchronous data folder is updated to the hard disk spaces, so that the data in the hard disk spaces are in the most updated state.

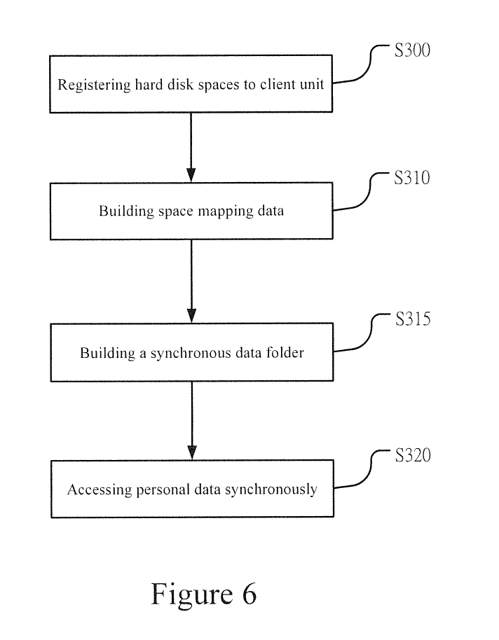

Moreover, the step of building a synchronous data folder can be executed after the step of building space mapping data. Thereby, as shown in FIG. 6, the method according to the present invention comprises the following steps:

Step S300: Registering hard disk spaces to the client unit;
Step S310: Building space mapping data;
Step S315: Building a synchronous data folder; and
Step S320: Accessing personal data synchronously.

Because the difference between FIG. 5 and FIG. 6 is only swapping the steps of building space mapping data and building a synchronous data folder, the details of the present embodiment will not be described again.

To sum up, the present invention provides a method for managing cloud hard disk spaces. The client unit is used for integrating the hard disk space on the Internet. In addition, the space mapping data are built. Hence, when a user accesses personal data to the hard disk spaces, the client unit can distribute the storage spaces of the personal data according to the space mapping data. Consequently, it is prevented that the user has to confirm the capacity of hard disk spaces one by one, and accessing personal data becomes more convenient.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for managing cloud hard disks, comprising steps of:
logging in a plurality of network hard disk spaces using a client unit through the Internet; and
said client unit distributing automatically and storing personal data to one of said plurality of network hard disk spaces when a user stores said personal data.

2. The method of claim 1, wherein said step of logging in a plurality of network hard disk spaces using a client unit through the Internet means that said client unit registers a plurality of account data and a plurality of capacity data of said plurality of hard disk spaces.

3. The method of claim 1, wherein said step of logging in a plurality of network hard disk spaces using a client unit through the Internet further includes a step of building space mapping data according to said plurality of hard disk spaces.

4. The method of claim 3, wherein said client unit further connects said plurality of hard disk spaces in series according to said space mapping data in said step of building space mapping data according to said plurality of hard disk spaces.

5. The method of claim 3, wherein said client unit distributes said personal data to said plurality of hard disk spaces according to said space mapping data in said step of said client unit distributing automatically and storing personal data to one of said plurality of network hard disk spaces.

6. The method of claim 1, and further comprising a step of building a synchronous file folder in said client unit after said step of logging in a plurality of network hard disk spaces using a client unit through the Internet.

7. The method of claim 6, wherein said client unit stores said personal data to said synchronous data folder for synchronizing said synchronous data folder to said plurality of hard disk spaces.

8. The method of claim 1, wherein a server further accesses said personal data according to the capacity of said plurality of hard disk spaces.

9. The method of claim 1, wherein said personal data includes multimedia data, word processing data, or chart and table data.
